(19) United States
(12) Patent Application Publication
(10) Pub. No.: US 2011/0008663 A1
(43) Pub. Date: Jan. 13, 2011

(54) FIXING MECHANISM AND ELECTRONIC DEVICE USING SAME

(75) Inventor: ZHI-HUA LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/548,655

(22) Filed: Aug. 27, 2009

(30) Foreign Application Priority Data
Jul. 7, 2009 (CN) 200910304090.2

(51) Int. Cl. H01M 2/10

(52) U.S. Cl. 429/96

(57) ABSTRACT

A fixing mechanism is used to fix a battery in a sleeve with a battery cover. The fixing mechanism includes at least one receiving groove defined in the battery cover, at least one latching portion defined in an inner side surface of the sleeve corresponding to the at least one receiving groove, at least one latching member received in the at least one receiving groove, and at least one resilient member movably compressed between the at least one latching member and a bottom of the at least one receiving groove. The at least one latching member is pushed by a restoring elastic force from the compressed resilient member to be engaged into the at least one latching portion.

### BACKGROUND

1. Technical Field

The present disclosure generally relates to fixing mechanisms and, particularly, to a fixing mechanism for fixing a battery cover to a sleeve, and an electronic device using the same.

2. Description of Related Art

An electronic device, such as a wireless keyboard, a wireless touchpad, a remote control, and the like, usually includes a battery to provide electrical power. For installation or removal of the battery, a detachable battery cover is often utilized.

A typical electronic device includes a battery, a sleeve, and a detachable battery cover. The sleeve defines a chamber to receive the battery. The battery cover includes a cover plate and a body portion extending downward from the cover plate. The sleeve further defines an inner screw threading in an inner surface of the chamber adjacent to the opening end. The body portion of the battery cover defines an outer screw threading corresponding to the inner screw threading, such that the body portion of the battery cover may be screwed into the opening end of the sleeve. However, it is relatively inconvenient to assemble or disassemble the battery cover to or from the sleeve.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a partial, isometric view of a first embodiment of an electronic device.

FIG. 2 is an exploded, isometric view of the electronic device of FIG. 1.

FIG. 3 is a cross-sectional view of the electronic device of FIG. 1, taken along line III-III.

FIG. 4 is a partial, isometric view of a sleeve of a second embodiment of an electronic device.

### DETAILED DESCRIPTION

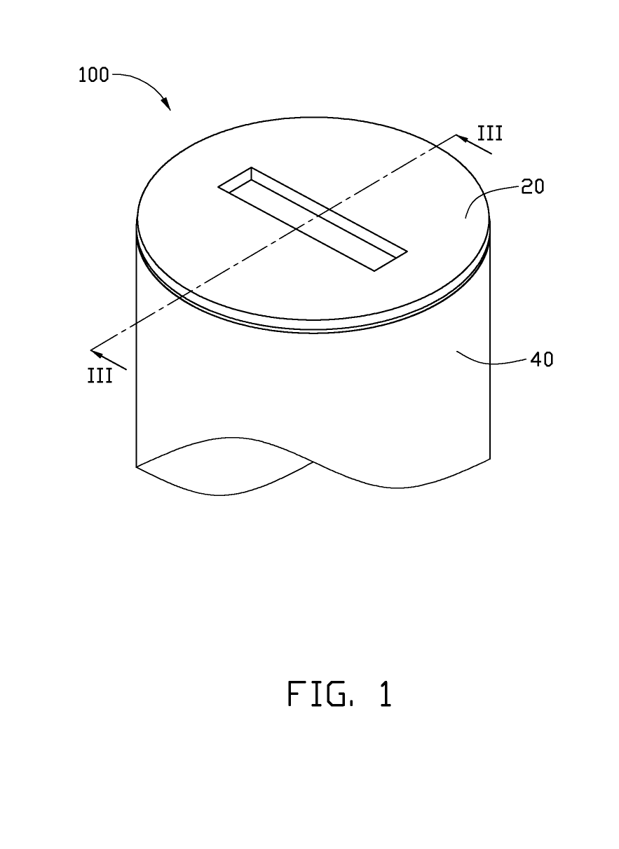

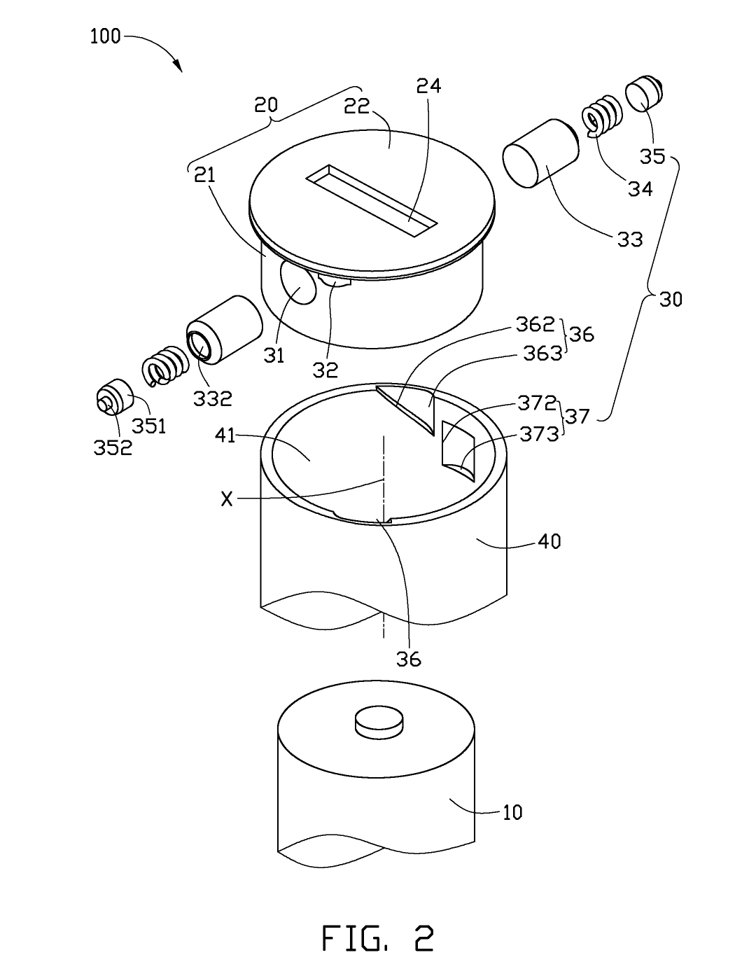

Referring to FIGS. 1 and 2, an electronic device 100 includes a battery 10, a battery cover 20, a fixing mechanism 30, and a sleeve 40. The fixing mechanism 30 fixes a battery 10 in the sleeve 40 with the battery cover 20. The electronic device 100 can be a wireless keyboard, a wireless touchpad, a remote control, and so on. The electronic device 100 includes various modules for performing corresponding function and features, however for simplicity, in one embodiment only the modules related to fix the battery 10 in the sleeve 40 with the battery cover 20 will be described. In the illustrated embodiment, the electronic device 100 is a wireless keyboard.

The sleeve 40 can be substantially cylindrical. The sleeve 40 defines a chamber 41 to receive the battery 10. The battery cover 20 includes a body portion 21 and a cover portion 22 formed at an end of the body portion 21. The body portion 21 is substantially cylindrical. The cover portion 22 is a circular plate. A diameter of the cover portion is greater than a diameter of the body portion 21. The body portion 21 may be inserted into the chamber 41 of the sleeve 40, and the cover portion 22 is blocked by the end of the sleeve 40.

The fixing mechanism 30 includes a pair of receiving grooves 31, a pair of limiting portions 32, a pair of barrels 33, a pair of resilient members 34, a pair of latching members 35, a pair of guiding portions 36, and a pair of latching portions 37. The receiving grooves 31 are defined in an outer side surface of the body portion 21 of the battery cover 20. In the illustrated embodiment, each receiving groove 31 is a substantially cylindrical depression. The two receiving grooves 31 are substantially symmetrical relative to a center axis X of the battery cover 20. The limiting portions 32 are protrusions extending out from the outer cylindrical surface of the body portion 21 adjacent to the receiving grooves 31. The two limiting portions 32 are also symmetrical relative to the center axis X of the battery cover 20.

Each barrel 33 is received in a corresponding receiving groove 31. Each barrel 33 defines a receiving space 332 at one end of each barrel 33. Each resilient member 34 can be a spring. Each latching member 35 includes a substantially cylindrical base 351 and a latching protrusion 352 extending from an end of the base 351. The resilient members 34 and the latching members 35 are received in the receiving space 332 of the barrels 33. Each resilient member 34 is movably compressed between the latching member 35 and a bottom of the barrel 33. An inner diameter of an opening of the receiving space 332 is slightly less than that of an inner side of the receiving space 332. A diameter of the base 351 of each latching member 35 is less than that of the inner side of the receiving space 332, and greater than that of the opening of the receiving space 332. Accordingly, the base 351 of each latching member 35 is blocked in the receiving space 322, and the latching protrusion 352 of each latching member 35 is exposed out of the barrel 35.

The pair of guiding portions 36 are formed at an inner side surface of the chamber 41 of the sleeve 40 corresponding to the pair of the limiting portions 32. The pair of latching portions 37 are formed at the inner side surface of the chamber 41 of the sleeve 40 corresponding to the pair of the receiving grooves 31. Accordingly, each guiding portion 36 is located adjacent to one of the latching portions 37.

Referring to FIG. 2 again, in the illustrated embodiment, each guiding portion 36 is a substantially triangular depression extending from an inner surface of an opening of the chamber 41 toward an inner side of the chamber 41. Each guiding portion 36 includes a guiding side surface 362 and a curved side surface 363 connected to the guiding side surface 362. The curved side surface 363 extends along a direction substantially parallel to the center axis X of the sleeve 40. The guiding side surface 362 is slanted relative to the curved side surface 363. Each latching portion 37 is a rectangular depression defined in a side of each curved side surface 363 of the guiding portion 36 away from the opening of the chamber 41. Each latching portion 37 includes a pair of latching side surfaces 373 and a curved side surface 372 connecting the pair of latching side surfaces 373.

The battery cover 20 further defines an operating slot 24 in a top surface of the cover portion 22 that can engage with a screwdriver to assemble and disassemble the battery cover 20 to and from the sleeve 40.

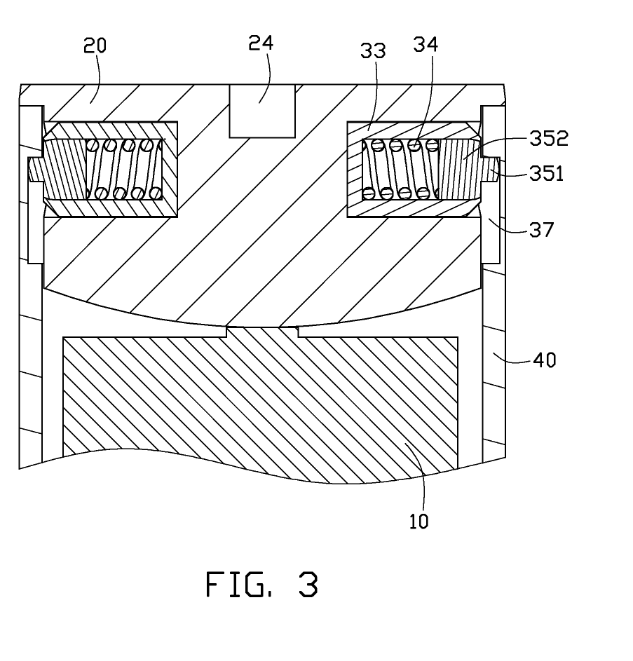

Referring to FIGS. 1 through 3, to fix the battery cover 20 to the sleeve 40, each resilient member 34 and each latching member 35 are first inserted into the corresponding barrel 33. A part of the barrel 33 adjacent to the opening of the receiving space 332 is then processed by a shrinkage casting method. Accordingly, the resilient member 34 is movably compressed between a bottom of the barrel 33 and the latching member 35. The base 351 of the latching member 35 is pushed by the compressed resilient member 34 and blocked by the barrel 33. The latching protrusion 352 of the latching member 35 is exposed out of the barrel 33. Each barrel 33 with the resilient member 34 and the latching member 35 is then received in the corresponding receiving groove 31. If an external force is applied to the latching protrusion 352 towards the resilient member 34, the resilient member 34 is further compressed, and the latching member 35 moves towards the resilient member 233. Next, the latching protrusions 352 of the latching members 35 are placed above the corresponding guiding portions 36, the battery cover 20 is rotated along a clockwise direction, and each latching protrusion 352 slides into the chamber 41 along the corresponding guiding side surface 362. Finally, the latching protrusions 352 of the latching members 35 are engaged into the corresponding latching portions 37, and the limiting portions 32 are received in the corresponding guiding portions 36. Accordingly, the battery cover 20 is fixed to the sleeve 40.

To disassemble the battery cover 20 from the sleeve 40, the battery cover 20 is rotated along a counter-clockwise direction. The latching protrusion 352 of the latching member 35 slides toward the guiding portion 36 along the curved side surface 372. At this time the latching protrusion 352 is pressed into the corresponding barrel 33, and the latching member 35 is detached from the corresponding latching portion 37.

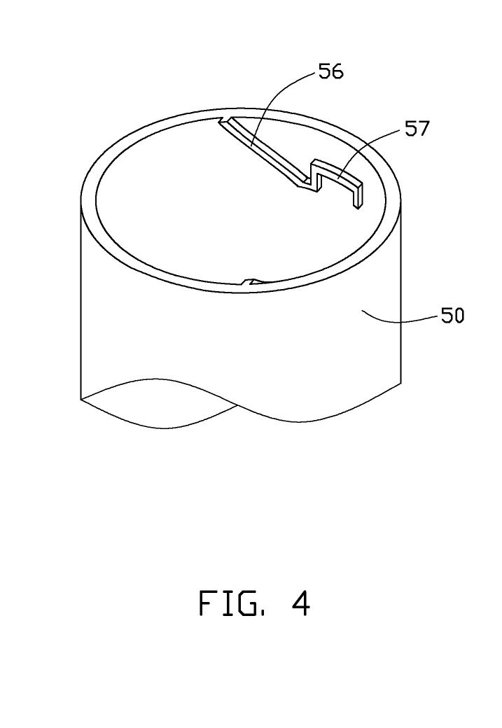

Referring to FIG. 4, in a second embodiment, a sleeve 50 includes a guiding portion 56 and a latching portion 57. The guiding portion 56 may be a slanted protrusion extending out from an inner side of the sleeve 50. The latching portion 57 may be an inverted U-shaped protrusion connecting with a bottom portion of the guiding portion 56. In this embodiment, the latching protrusions 352 may slide into a chamber of the sleeve 50 along the corresponding guiding portion 56, and finally, the latching protrusions 352 are engaged into the corresponding latching portions 57.

It should be pointed out that the barrels 33, the limiting portions 32 and the guiding portions 36 may be omitted. It is noted that the scope of the receiving grooves 31, the limiting portions 32, the barrels 33, the resilient members 34, the latching members 35, the guiding portions 36, and the latching portions 37 are not limited to the embodiment described above. The numbers of the receiving grooves 31, the limiting portions 32, the barrels 33, the resilient members 34, the latching members 35, the guiding portions 36, and the latching portions 37, are specifically described and illustrated for the purpose of exemplifying various aspects of the present electronic device 100.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A fixing mechanism for fixing a battery in a sleeve with a battery cover, the fixing mechanism comprising:
at least one receiving groove defined in the battery cover;
at least one latching portion defined in an inner side surface of the sleeve corresponding to the at least one receiving groove;
at least one latching member received in the at least one receiving groove; and
at least one resilient member movably compressed between the at least one latching member and a bottom of the at least one receiving groove, wherein the at least one latching member is pushed by a restoring elastic force from the compressed resilient member to be engaged into the at least one latching portion.

2. The fixing mechanism of claim 1, wherein the battery cover comprises a body portion and a cover portion formed at an end of the body portion; the at least one receiving groove is defined in an outer side surface of the body portion.

3. The fixing mechanism of claim 2, wherein the at least one latching portion is a depression defined in the inner surface of the sleeve, the at least one latching portion comprises a pair of latching side surfaces and an curved side surface connecting the pair of latching side surfaces.

4. The fixing mechanism of claim 3, further comprising at least one guiding portion defined at an inner side surface of the sleeve adjacent to an opening of the sleeve, and at least one limiting portion extending out from the outer side surface of the body portion adjacent to the at least one receiving groove corresponding to the at least one guiding portion; the at least one limiting portion is engaged with the at least one guiding portion.

5. The fixing mechanism of claim 4, wherein the at least one guiding portion is a substantially triangular depression extending from an inner surface of the opening of the sleeve toward inside the sleeve, the at least one guiding portion comprising a curved side surface extending along a direction substantially parallel to a center axis of the sleeve, and a guiding side surface slanted relative to the curved side surface and connecting the curved side surface.

6. The fixing mechanism of claim 1, wherein the at least one latching member comprises a base and a latching protrusion extending from an end of the base and engaged in the at least one latching portion.

7. The fixing mechanism of claim 6, further comprising at least one barrel disposed in the at least one receiving groove, the at least one barrel defining a receiving space to receive the at least one latching member and the at least one resilient member; the at least one resilient member is movably compressed between the base of the at least one latching member and a bottom of the at least one barrel.

8. The fixing mechanism of claim 7, wherein an inner diameter of an opening of the receiving space of the at least one barrel is slightly less than that of an inner side of the receiving space; the base of the at least one latching member is blocked in the receiving space; and the latching protrusion of the at least one latching member is exposed out of the at least one barrel.

9. The fixing mechanism of claim 2, wherein the battery cover further defines an operating slot in a top surface of the cover portion.

10. An electronic device, comprising:
a sleeve;
a battery received in the sleeve;
a battery cover; and
a fixing mechanism to fix the battery in the sleeve with the battery cover, the fixing mechanism comprising at least one receiving groove defined in the battery cover, at least one latching portion defined in an inner side surface of the sleeve corresponding to the at least one receiving groove, at least one latching member received in the at least one receiving groove, and at least one resilient member movably compressed between the at least one latching member and a bottom of the at least one receiving groove, wherein the at least one latching member is pushed by a restoring elastic force from the compressed resilient member to be engaged into the at least one latching portion.

11. The electronic device of claim 10, wherein the battery cover comprises a body portion and a cover portion formed at an end of the body portion; the at least one receiving groove is defined in an outer side surface of the body portion.

12. The electronic device of claim 11, wherein the at least one latching portion is a depression defined in the inner surface of the sleeve, the at least one latching portion comprises a pair of latching side surfaces and a curved side surface connecting the pair of latching side surfaces.

13. The electronic device of claim 12, further comprising at least one guiding portion defined at an inner side surface of the sleeve adjacent to an opening of the sleeve, and at least one limiting portion extending out from the outer side surface of the body portion adjacent to the at least one receiving groove corresponding to the at least one guiding portion, the at least one limiting portion is engaged with the at least one guiding portion.

14. The electronic device of claim 13, wherein the at least one guiding portion is a substantially triangular depression extending from an inner surface of the opening of the sleeve toward inside the sleeve, the at least one guiding portion comprising a curved side surface extending along a direction substantially parallel to a center axis of the sleeve, and a guiding side surface slanted relative to the curved side surface and connecting the curved side surface.

15. The electronic device of claim 10, wherein the at least one latching member comprises a base and a latching protrusion extending from an end of the base and engaged in the at least one latching portion.

16. The electronic device of claim 15, further comprising at least one barrel disposed in the at least one receiving groove, the at least one barrel defining a receiving space to receive the at least one latching member and the at least one resilient member; the at least one resilient member is movably compressed between the base of the at least one latching member and a bottom of the at least one barrel.

17. The electronic device of claim 16, wherein an inner diameter of an opening of the receiving space of the at least one barrel is slightly less than that of an inner side of the receiving space; the base of the at least one latching member is blocked in the receiving space, and the latching protrusion of the at least one latching member exposes out of the at least one barrel.

18. The electronic device of claim 11, wherein the battery cover further defines an operating slot in a top surface of the cover portion.
